(19) United States
(12) Patent Application Publication
(10) Pub. No.: US 2026/0196089 A1
(43) Pub. Date: Jul. 9, 2026

(54) Electronic Tag

(71) Applicant: AUTHENA AG, Zug (CH)

(72) Inventors: Dejan Milenovic, Horgen (CH); Matteo Panzavolta, Ruischlikon (CH); Milosz Tokarski, Wroclaw (PL)

(21) Appl. No.: 18/855,440

(22) PCT Filed: Apr. 11, 2023
(86) PCT No.: PCT/EP2023/059436

§ 371 Date: Oct. 9, 2024

(30) Foreign Application Priority Data
Apr. 11, 2022 (CH) CH000411/2022

(51) Int. Cl. G07C 9/20

(52) U.S. Cl. CPC G07C 9/215

(57) ABSTRACT

An electronic tag is disclosed comprising an electronic tamper detecting circuit, a wireless communication circuit, an environmental sensor including one or more of: a temperature or a humidity sensor, an energy storage module, and a control module, wherein the control module is configured to record, in a non-volatile memory of the control module, environmental measurement values received from the environmental sensor, tamper status indicators received from the electronic tamper detecting circuit, and transmit a status message comprising the environmental measurement values and the tamper status indicators to a wireless reader.

### FIELD OF THE DISCLOSURE

The present disclosure relates to an electronic tag for monitoring a portable product.

### BACKGROUND OF THE DISCLOSURE

Tags are known which are attached to a product container or products themselves, for example by a tie, or by using an adhesive (i.e. a tag in the form of a label). Simple tags are used to record information about the product, for example a product name, product manufacturer, instructions related to the use of the product, certifications related to the product, etc. Tags can also feature a printed machine-readable visual code, for example in the form of a barcode or a QR code, which enables a barcode scanner, for example, to identify the product. These types of tags are typically made from die-cut plastics, papers, metals, or other materials and have information printed on them. Such tags are in everyday use, from food items to cardboard shipping boxes.

More recent developments in the field of tags include the use of electronic circuitry, in particular RFID circuitry, to allow a product scanner to read digital information from the tag electronically. RFID tags have some advantages over machine-readable visual code, for example they do not require a line of sight with a scanner, and they are able to store more data. Such tags are gaining widespread use, for example in the airline industry, where luggage is typically tracked using an adhesive tag containing an RFID circuit.

Tamper-evident labels are also known which have one or more indicators or barriers to entry which, if breached or missing, provide visible evidence that tampering has occurred. Items such as over-the-counter drugs and packaging materials use these types of labels on their products. Tamper-evident labels are attached to the product or container in such a way as to prevent access to the product or container without leaving visible evidence. For example, tamper-evident labels feature slits or weakened portions, or particular types of adhesive, such that attempted removal of the tamper-evident label results in visible damage.

U.S. Pat. No. 10,282,953 discloses an electronic tamper detection device comprising a radio frequency antenna, a tamper loop, a power determination unit and a tamper measurement unit.

EP3734513 A1 discloses a tamper detection device comprising an integrated circuit chip, an antenna, a tamper loop, and a light emitting diode which is activated upon a signal received by the antenna and depending on the condition of the tamper loop.

### SUMMARY OF THE DISCLOSURE

It is an object of this disclosure to provide an electronic tag for monitoring a portable product which overcomes one or more disadvantages of the prior art.

In particular, it is an object of this disclosure to provide an electronic tag for monitoring a portable product which detects tampering electronically.

According to the present disclosure, the above-mentioned objects are achieved by an electronic tag comprising an electronic tamper detecting circuit configured to detect a change in a quantity measure of a product with which the electronic tag is associated, and generate a tamper status indicator upon a change in the quantity measure being detected. The electronic tag comprises a wireless communication circuit, an environmental sensor including a temperature sensor and/or humidity sensor, an energy storage module, and a control module. The control module is connected to the electronic tamper detecting circuit, the wireless communication circuit, the environmental sensor, and the energy storage module. The control module is configured to record, in a non-volatile memory of the control module, environmental measurement values received from the environmental sensor. The control module is configured to record, in the memory, tamper status indicators received from the electronic tamper detecting circuit. The control module is configured to transmit, to a wireless reader, a status message comprising at least one of: one or more of the environmental measurement values and/or one or more of the tamper status indicators.

In an embodiment, the wireless communication circuit is a Bluetooth circuit (in particular, Bluetooth Low Energy (BLE)), and/or a radio-frequency identification (RFID) circuit.

In an embodiment, the RFID circuit is a low frequency RFID circuit, a high frequency RFID circuit, and/or an ultra-high frequency RFID circuit.

In an embodiment, the electronic tamper detecting circuit is configured to detect the change in the quantity measure as a change in a fill level of a liquid in the product to which the electronic tag (1) is attached. The electronic tamper detecting circuit is configured to generate the tamper status indicator upon the fill level falling below a predetermined fill level threshold.

In an embodiment, the electronic tamper detecting circuit comprises a capacitive sensor configured to detect the change in the fill level as a change in capacitance.

In an embodiment, the electronic tamper detecting circuit is configured to detect the change in the quantity measure as a change in weight of the product to which the electronic tag is attached. The electronic tamper detecting circuit is configured to generate the tamper status indicator upon the weight falling below a predetermined weight threshold.

In an embodiment, the electronic tamper detecting circuit comprises a weight detector arranged in an extension of the electronic tag, the extension connected to a main body of the electronic tag by a flexible connector, the weight detector configured to detect the change in weight.

In an embodiment, the radio-frequency identification circuit is a near-field communication (NFC) circuit.

In an embodiment, the memory is further configured to store product information including: an identifier of the electronic tag, an identifier of a portable product to which the electronic tag is attached, a name of the product, a description of the product, a serial number of the product, a batch number of the product, a manufacturer of the product, a production date of the product, an expiration date of the product, and/or a Uniform Resource Locator (URL). The URL is, for example, a web address that points to a web site comprising information related to the product.

In an embodiment, the memory is configured to store an encryption key and the control module is further configured to encrypt the status message or parts thereof, using the encryption key.

In an embodiment, the memory is configured to store an address of a remote computer system and the status message is configured to comprise a message addressing part including the address of the remote computer system. The status message is thereby configured to enable the wireless reader to forward the status message to the remote computer system.

In an embodiment, the energy storage module comprises a battery and/or a capacitor.

In an embodiment, the electronic tag further comprises an energy-harvesting circuit connected to the control module, the energy-harvesting circuit comprising: a thermoelectric generator, a radio-frequency energy harvesting system, a piezoelectric energy harvesting module, and/or a photovoltaic module.

In an embodiment, the electronic tamper detecting circuit is arranged to detect tampering by detecting whether a portable product, to which the electronic tag is attached to, has been accessed, or removed from the electronic tag.

In an embodiment, the tamper detecting circuit comprises a detection wire and a tamper measurement unit configured to generate a measurement signal and to transmit the measurement signal through the detection wire. The tamper measurement unit is configured to receive the measurement signal from the detection wire. The tamper measurement unit is configured to detect tampering by determining a change in the received measurement signal. The tamper measurement unit is configured to provide the tamper status indicator, indicative of whether tampering has occurred or not, to the control module. For example, the tamper status indicator is provided to the control module by storing the tamper status indicator in a memory readable by the control module, or by transmitting the tamper status indicator to the control module.

In an embodiment, the electronic tag is implemented on a flexible circuit board and comprises an adhesive backing.

In an embodiment, the electronic tag further comprises a bi-stable display connected to the control module, wherein the control module is configured to display information, using the bi-stable display, in one or more of: a human-readable format or a machine-readable format.

In an embodiment, the information displayed by the bi-stable display relates to: one or more of the environmental measurement values, one or more of the tamper status indicators, and/or product information.

In addition to the electronic tag described above, the present disclosure also relates to a wireless reader configure to receive, via a wireless transmission, from the electronic tag described herein, a status message.

The wireless reader is, for example, configured to communicate using Bluetooth, in particular Bluetooth Low Energy (BLE). The wireless reader may, additionally or alternatively, be configured to communicate using RFID.

In an embodiment, the wireless reader is configured to forward the received status message to a remote computer system, according to an address of the remote computer system contained in a message addressing part of the status message.

In an embodiment, the wireless reader is further configured to receive a plurality of status messages from a plurality of electronic tags in communicative range, respectively. The wireless reader is configured to record, in a memory of the radio-frequency identification reader, the plurality of status messages. The wireless reader is configured to determine, for each status message received, whether the status message indicates that the environmental measurement values satisfy one or more pre-defined criteria and whether the tamper status indicators indicate that tampering has occurred. The RFID reader is configured to generate an event message if, for one or more status messages, the environmental measurement values do not satisfy the one or more pre-defined criteria or if the tamper status indicators indicate that tampering has occurred.

In an embodiment, the event message comprises event information relating to the one or more status messages, the electronic tag(s) relating to the one or more status message and/or the product(s) associated with the one or more status messages. The event information may comprise, for example, the particular measurement value(s) which exceed the pre-defined criteria, preferably including the time-stamp. The event information may further comprise, for example, the particular tamper status indicator(s) indicating that tampering has occurred, preferably including the time-stamp.

In an embodiment, the wireless reader is configured to display the event message on a display of the wireless reader. Additionally, or alternatively, the wireless reader is configured to transmit the event message to a third device, for example a remote computer system.

In an embodiment, the wireless reader is configured to compare information received in the status messages with a stored inventory list, the inventory list comprising product information relating to the plurality of products attached to the plurality of electronic tags, respectively. The wireless reader is configured to generate the event message if the information received in the status messages does not match the information of the inventory list.

In addition to the electronic tag and the wireless reader, the present disclosure also relates to a system comprising an wireless reader as disclosed herein, and a plurality of electronic tags as described herein, the electronic tags being arranged within communication range of the wireless reader and configured to transmit status messages to the wireless reader.

### BRIEF DESCRIPTION OF THE DRAWINGS

The present disclosure will be explained in more detail, by way of example, with reference to the drawings in which:

FIG. 1: shows a block diagram schematically illustrating an electronic tag for monitoring a portable product;

FIG. 2: shows a block diagram schematically illustrating an electronic tag attached to a portable product in data communication with an RFID reader;

FIG. 3: shows a block diagram schematically illustrating an energy storage module;

FIG. 4: shows a block diagram schematically illustrating an energy harvesting circuit;

FIG. 5: shows a block diagram schematically illustrating a tamper detecting circuit;

FIGS. 6a, 6b: show schematically two implementations of an electronic tag for monitoring a portable product;

FIGS. 7a, 7b: show schematically two implementations of an electronic tag for monitoring a portable product;

FIG. 8: shows a block diagram schematically illustrating a section of an electronic tag for monitoring a portable product;

FIGS. 9a to 9e show block diagrams schematically illustrating a section of a number of implementations of electronic tags for monitoring a portable product;

FIGS. 10a, 10b show schematically two embodiments illustrating an electronic tag attached to a product;

FIGS. 11a, 11b show schematically an electronic tag attached to a bottle, in a partial cut-away perspective view and in a perspective view showing components of the electronic tag;

FIGS. 12a, 12b show schematically an electronic tag prior to attachment to a product, in a partial cut-away view and in a view showing components of the electronic tag;

FIGS. 13a, 13b show schematically an electronic tag in a curved form after application to a product, in a partial cut-away view and in a view showing components of the electronic tag;

FIG. 14 shows schematically a process of applying an electronic tag to a bottle;

FIG. 15 shows schematically a part of an electronic tag which includes a capacitive sensor configured to detect the change in the fill level;

FIG. 16 shows schematically a part of an electronic tag which includes a capacitive sensor configured to detect the change in the fill level;

FIG. 17 shows schematically a part of an electronic tag which includes a capacitive sensor configured to detect the change in the fill level;

FIG. 18 shows schematically an electronic tag, in a flat state, with a weight detector arranged in an extension of the electronic tag;

FIG. 19 shows schematically the electronic tag of FIG. 18 in a curved state with the extension in a folded state;

FIG. 20 shows schematically a cut-away view of the electronic tag of FIG. 18 applied to a bottle; and

FIG. 21 shows schematically the electronic tag of FIG. 19 including a cover.

### DETAILED DESCRIPTION OF EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that his disclosure will satisfy applicable legal requirements. Whenever possible, like reference numbers will be used to refer to like components or parts.

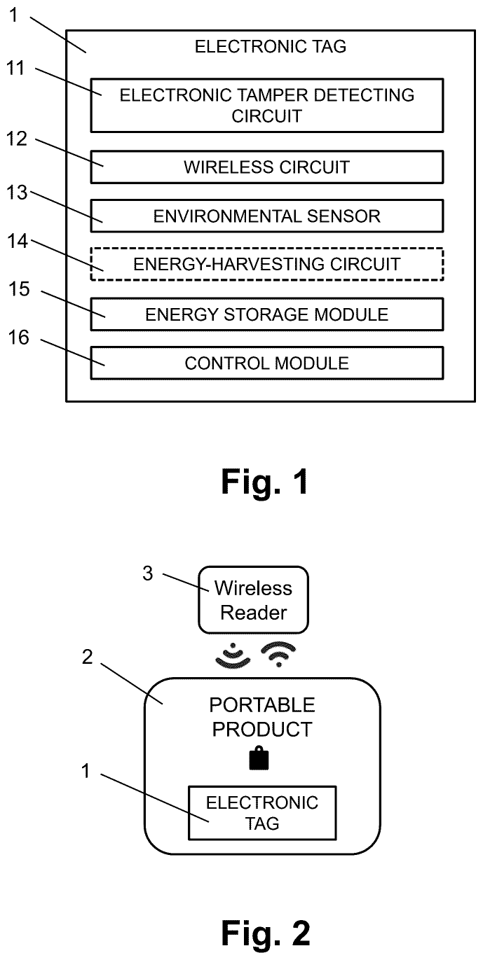

FIG. 1 shows a block diagram illustrating schematically an electronic tag 1 and various components thereof. The electronic tag 1 is attachable to an item, for example attachable to a product (in particular a portable product), a packaging of a product, or a container (e.g. for storage and/or transportation of a product), or the like. In the following description, reference will be made to the electronic tag 1 being attached to a product, however this is intended to be understood as being a reference to any of the above-mentioned items.

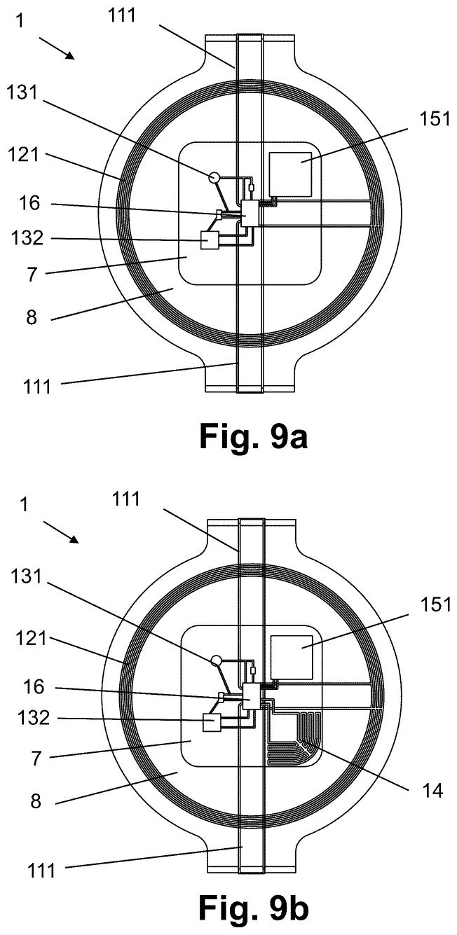

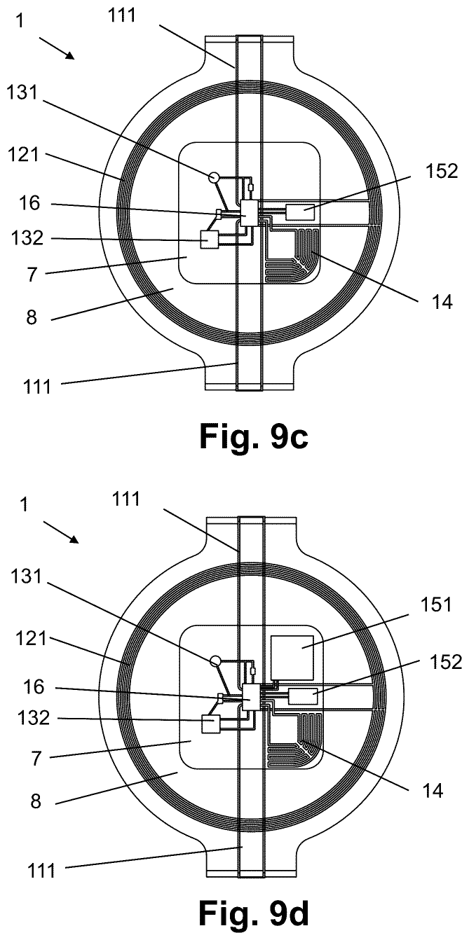

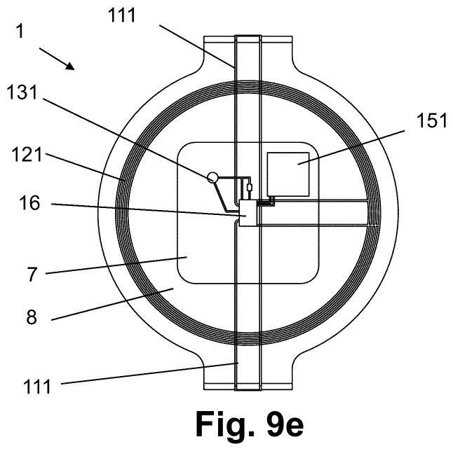

Examples of products for which the electronic tag 1 is particularly suited include products required to be transported and/or stored under specific environmental conditions, such as perishable products, medicaments, and chemicals. For such products the electronic tag 1 presents a simple and reliable solution to monitoring and recording environmental conditions over time while also recording information relating to tampering. Depending on the different requirements of the product and the circumstances in which the product is required to be monitored, the electronic tag 1 has different features, as explained below in more detail with reference to FIG. 9.

Preferably, the electronic tag 1 is attachable by attachment means directly integrated with the electronic tag 1. For example, the attachment means include an adhesive, such that the electronic tag 1 can be glued or bonded to the product. The adhesive can alternatively be applied first to the product itself, with the electronic tag 1 subsequently being attached. Alternatively, or additionally, the electronic tag 1 comprises a tie, loop, or hole for receiving such a tie or loop, for attachment to the product.

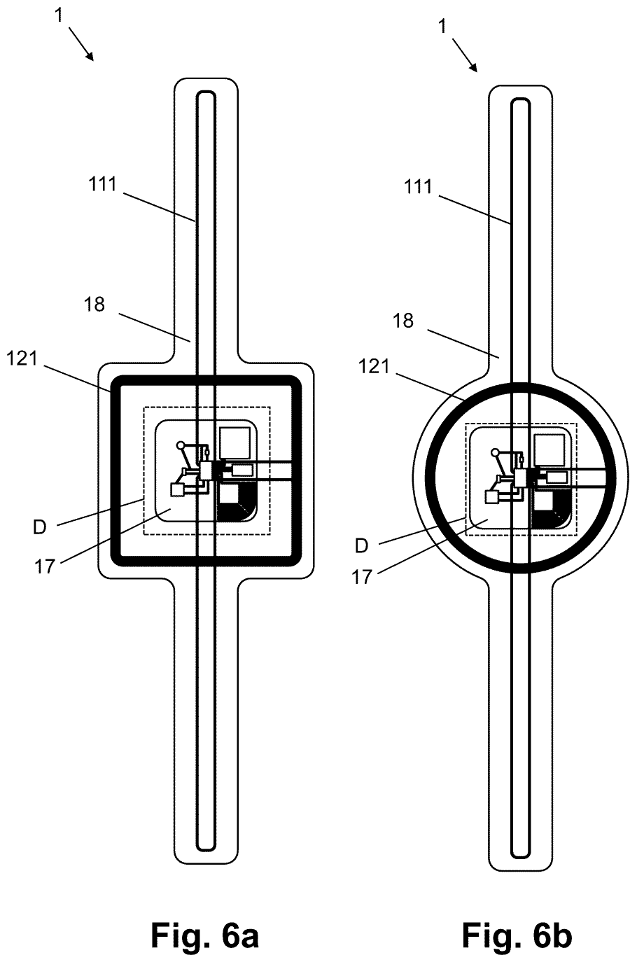

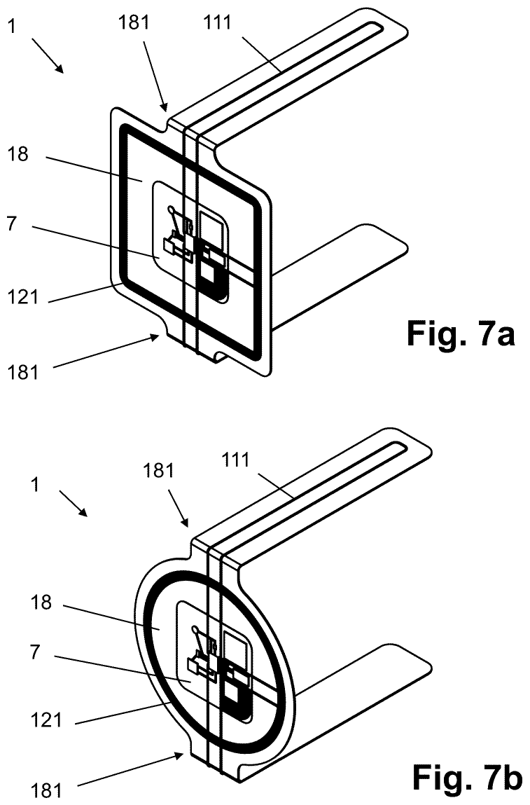

As is explained below in more detail, for example with reference to FIGS. 6 and 7, the electronic tag 1 is, in an embodiment, flat and flexible such that it can be applied to a curved surface of a product, for example a bottle.

The electronic tag 1 comprises an electronic tamper detecting circuit 11, which is explained in more detail with reference to FIG. 5. The electronic tamper detecting circuit 11 is configured to detect a tamper attempt. The tamper attempt can include, for example, an attempt to remove the electronic tag 1 from the product or an attempt to gain access to the product (respectively the package or container containing the product). The electronic tamper detecting circuit 11 provides (e.g. transmits) a tamper status indicator to a control module 16.

The tamper attempt can include, for example, removing (or partially removing) contents of the product or removing the product itself. For example, the contents of the product may be liquid contents, powder or granulate contents, or discrete contents (e.g., pills).

The electronic tag 1 comprises a wireless circuit 12. The wireless circuit 12 is configured for wireless radio communication according to one or more communications standards. The wireless circuit 12 may be configured to communicate actively or passively. By active communication, we refer to communication prompted by the electronic tag 1 itself based on an internal condition. In particular, active communication requires the electronic tag 1 to provide the energy for the communication by itself (the energy, however, may be ambient energy harvested from the environment). By passive communication, we refer to communication prompted or initiated by a wireless reader 3. In particular, for passive communication, the energy for the operation and communication of the electronic tag 1 typically is transmitted by the wireless reader 3 to the electronic tag 1.

The wireless circuit 12 of the electronic tag 1 may comprise a Bluetooth circuit, in particular a Bluetooth Low Energy (BLE) circuit.

The wireless circuit 12 of the electronic tag 1 may comprise a radio-frequency identification (RFID) circuit 12. The RFID circuit 12 comprises an RFID control circuit and an RFID antenna 121 (not shown). Depending on the embodiment, the RFID circuit 12 includes a low frequency (LF) RFID circuit (for example as defined in the ISO 14223, and ISO/IEC 18000-2 standards), a high frequency (HF) RFID circuit (for example as defined in the ISO 15693 standard), and/or an ultra-high frequency (UHF) RFID circuit (according to the EPCGlobal Gen2 (ISO 18000-63) standard). In an embodiment, the HF RFID circuit 12 is a near-field communication (NFC) circuit (for example, using the ECMA-340 or ISO/IEC 18092 standards).

In an embodiment, the RFID circuit 12 is a passive RFID circuit 12 which is configured such that an RFID reader 3 (not shown) can communicate with the RFID circuit 12 without the RFID circuit 12 requiring a dedicated power supply, i.e. the RFID reader 3 supplies the power for the RFID circuit 12 via an electromagnetic signal and the RFID circuit 12 is thereby passively powered. Additionally, the power received passively by the RFID reader 3 can be used to power other electronic components of the electronic tag 1, in particular the control module 16.

In an embodiment, the RFID circuit 12 is an active RFID circuit 12 which is powered by a dedicated power supply, in particular an energy storage module 15 of the electronic tag. Thereby, the RFID circuit 12 does not require the RFID reader 3 to power the RFID circuit 12. Such an active RFID circuit 12 has as greater transmission range than the passive RFID circuit 12 described above.

In an embodiment, the RFID circuit 12 has an active mode and a passive mode, wherein the RFID circuit 12 is configured to switch from an active mode to a passive mode if a power level of the energy storage module 15 falls below a pre-determined threshold value, and wherein the RFID circuit 12 is configured to switch from a passive mode to an active mode if the power level of the energy storage module 15 rises above the pre-determined threshold value. In the active mode, the electronic tag 1, in particular the control module 16 and/or the RFID circuit 12, is powered by the energy storage module 15. In the passive mode, the electronic tag 1, in particular the control module 16 and/or the RFID circuit 12, is powered by a received signal, in particular a signal received from the RFID reader 3.

The electronic tag 1 further comprises an environmental sensor 13. The environmental sensor 13 includes a temperature sensor 131 (shown in FIGS. 6 to 9) and/or a humidity sensor 132 (shown in FIGS. 6 to 9). The environmental sensor 13 is configured to directly or indirectly measure a temperature of the product. The environmental sensor 13 is configured to provide (e.g. transmit) a plurality of environmental measurement values, in particular temperature values and/or humidity values, to a control module 16. The temperature sensor 131 may be covered by an insulating and/or reflecting layer such that a measured temperature more accurately reflects the temperature of the product 2 and external influences, for example sunlight, do not lead to spuriously high measured values. The humidity sensor 132 is preferably implemented such that it is physically connected to the environment, either by having a direct air contact to measure the humidity of the air, or being separated by a porous membrane.

The electronic tag 1 further comprises an energy storage module 15. The energy storage module is configured to store electrical energy and provide electrical energy to other components of the electronic tag 1. The energy storage module 15 is rechargeable. The energy storage module 15 is described in more detail with reference to FIG. 2.

In an embodiment, the electronic tag 1 further comprises an energy-harvesting circuit 14. The energy-harvesting circuit 14 is configured to generate electrical power from the environment. The energy-harvesting circuit 14 is described in more detail with reference to FIG. 4.

The electronic tag 1 further comprises a control module 16. The control module 16 is implemented, for example, as one or more electronic chips, for example one or more integrated circuits, microcontrollers, microprocessors, application specific circuits (ASICs), or the like. The control module 16 further comprises, depending on the embodiment of the invention, analog circuitry configured to measure and/or generate analog signals.

The control module 16 is powered by the energy storage module 15. In an embodiment, the control module 16 is alternatively or additionally powered by the wireless reader 3. In particular, the environmental sensor 13 and/or the tamper detecting circuit 11 is capable of being powered by the wireless reader 3. Thereby, even if the energy storage module 15 does not have sufficient power left (. e.g., the battery is depleted) to power the electronic tag 1, the wireless reader 3 can provide power via radiation and/or induction to temporarily power the electronic tag 1, in particular to record a current environmental measurement value and/or a current tamper status indicator.

The control module 16, depending on the implementation, is further configured to include, in whole or in part, the electronic tamper detecting circuit 11 and/or the wireless circuit 12. In particular, the control module 16, and at least parts of the electronic tamper detecting circuit 11 and/or the wireless circuit 12 are implemented on a single electronic chip.

The control module 16 comprises a memory comprising volatile (non-persistent) and/or non-volatile (persistent) memory. For example, the memory is implemented as solid state memory (e.g. flash memory). The memory is configured to store program code, firmware, software applications, and/or software libraries. Additionally, the memory is configured to store data relating to the aforementioned.

The control module 16 is configured to carry out one or more steps and/or functions as described herein. Specifically, the memory is configured to store program code (for example, as firmware, software application(s), and/or software libraries) configured to control the control module 16 such that it carries out one or more of the steps and/or functions as described herein.

In particular, the control module 16 is configured to record, at a regular pre-defined frequency, the environmental measurement values and/or the tamper status indicator. The pre-defined frequency depends on the particular implementation and is configured to be, for example, every second, every 10 seconds, or every minute.

The control module 16 is further configured, for example, to aggregate the environmental measurement values and to store an average value, averaged over a pre-defined time-period.

In an embodiment, the control module 16 is further configured to compress or otherwise store the data in an efficient manner. As described above, averaged environmental measurement values can be stored. Additionally, or alternatively, only environmental measurement values deviating from a previously stored value by more than a particular deviation threshold are stored. Similarly, the control module 16 can be configured only to store tamper status indicators which deviate from a previously stored tamper status indicator. In these embodiments it is preferable to store each environmental measurement value and the tamper status indicator with an appropriate time stamp.

The control module 16 comprises, in an embodiment, a digital clock configured to provide a time-stamp indicating a current time.

To this end, the components, in particular the electronic components, of the electronic tag 1, are preferably implemented as flexible components. For example, the electronic components are implemented on a flexible printed circuit board (FPCB). The electronic components may be implemented on one or more circuit boards connected to each other via a connection mechanism as described below, in particular using flexible flat band connectors.

The control module 16 is connected to the other components of the electronic tag 1, in particular the other electronic components of the electronic tag 1, either directly or indirectly, using a connection mechanism. The connection mechanism facilitates a transfer of electrical energy and/or a wired data communication. In particular, the control module 16 is connected to the electronic tamper detecting circuit 11, the wireless circuit 12, the environmental sensor 13, and/or the energy storage module 15. The control module 16 may also be connected to the energy-harvesting circuit 14.

The memory is also configured to store the environmental measurement values, in particular the temperature values and/or the humidity values. The memory is also configured to store the tamper status indicators indicative of whether tampering has occurred, as provided by the tamper detecting circuit 11. The memory is also configured to store product information relating to the electronic tag 1 or the portable product 2 attached to the electronic tag 1. In particular, the product information includes an identifier of the electronic tag 1, an identifier of a portable product 2 to which the electronic tag is attached, a name of the product 2, a description of the product 2, a serial number of the product 2, a batch number of the product 2, a manufacturer of the product 2, a production date of the product 2, an expiration date of the product, and/or a Uniform Resource Locator (URL). The URL is, for example, a web address that points to a web site comprising information related to the product 2.

The memory, in whole or in part, is accessible by the wireless reader 3, in particular via the wireless circuit 12.

Depending on the embodiment, the memory comprises two or more parts. In particular a first part is configured to store the program code, the firmware, the software applications, and/or the software libraries. The second part is configured to store the environmental measurement values, the tamper status indicators, and/or the product information. The memory parts may be physically distinct memory modules, or logically distinct partitions of a single memory module.

The first part of the memory is preferably configured to be inaccessible to the wireless reader 3 and configurable only during manufacture or commission of the electronic tag.

The second part of the memory is preferably configured to be writable only by the electronic tag 1 itself, in particular not writable by the wireless reader 3. Thereby, it is not possible to overwrite data related to the environmental measurement values or the tamper status indicators, for example. As such, the second part of the memory is preferably configured to be read-only.

As explained above, depending on the implementation, the memory is configured to be partly or fully read-only, such that at least part of the memory is protected from being overwritten. For example, the firmware is read-only, i.e. the firmware is stored in an area of the memory which cannot be overwritten. In another example, the identifier of the electronic tag 1, the environmental measurement values, and the tamper status indicators are read-only, i.e. they are stored in an area of the memory which cannot be overwritten by an external device, in particular an wireless reader 3.

The data mentioned herein as being stored on read-only parts of the memory are understood as being either written to during manufacture of the electronic tag 1 or during application of the electronic tag 1 to the product. Once the electronic tag 1 has been manufactured or applied to the product, the electronic tag 1 is switched to a read-only mode either using a software command, e.g. received via the wireless circuit 12, or by destruction of a sacrificial component, for example a resistor which is subject to a high current.

In an embodiment, the memory is configured to store a cryptographic key, in particular in a third part, the third part preferably being a physically distinct memory module. The cryptographic key is used, for example, to digitally sign the environmental measurement values and/or the tamper status indicators. Additionally, the cryptographic key is used, in an embodiment, to validate and/or establish a secure connection with the wireless reader 3, or with a further external device, via the wireless reader 3.

In an embodiment, the memory is configured to store, in particular in a part readable by the wireless reader 3, an address of a remote computer system.

In an embodiment, the electronic tag 1 further comprises a bi-stable display connected to the control module 16. The term bi-stable means that the display requires power only when switching states, i.e. only when updating a displayed image. In particular, the bi-stable display does not require any power to maintain a displayed image. The bi-stable display is implemented as, for example, an E-Ink display (e.g., black and white or colour). The bi-stable display may be implemented as a thin film display, preferably a flexible thin film display. The bi-stable display is implemented on the same circuit board as other electronic components of the electronic tag 1, in particular the control module 16.

Alternatively, the bi-stable display is implemented on a second circuit board, connected to the circuit board of the control module 16 via the connection mechanism, in particular using a flexible flat band cable. In this example, the bi-stable display is preferably arranged such that it covers at least some of the other electronic components of the electronic tag 1, in particular the control module 16. This results in a more compact electronic tag 1.

The bi-stable display is configured to display information transmitted from the control module 16. In particular, the bi-stable display is configured to display information in a human-readable format and/or a machine-readable format. The human-readable format comprises, for example, text characters, charts, and graphic. The machine-readable format comprises, in particular, barcodes, such as two-dimensional barcodes (e.g., a QR code).

In an embodiment, the information displayed by the bi-stable display relates to one or more of the environmental measurement values (in particular one or more of the most recent environmental measurement values), one or more of the tamper status indicators (in particular one or more recent tamper status indicators, and/or the product information. The environmental measurement values and/or the tamper status indicators are preferably displayed with a time-stamp.

In an embodiment, the information displayed further comprises an alarm message. The alarm message is displayed if one or more pre-defined criteria are met. For example, if the environmental measurement values do not satisfy one or more pre-defined environmental criteria (e.g., the temperature values are higher than a defined maximum temperature, or below a defined minimum temperature), the alarm message is displayed. For example, if the tamper status indicator indicates that tampering has occurred, the alarm message is displayed. The alarm message is preferably displayed in a visually prominent manner, for example, the alarm message is displayed large enough such that is recognizable from a distance rather than merely up-close.

Depending on the embodiment, the QR code is configured to encode the product information. Specifically, the QR code is configured to encode the URL to a product website comprising product information or further details regarding the product. The QR code may also encode one or more of the environmental measurement values and/or the tamper status indicators. The QR code is readable using an external device, for example a smart phone equipped with a camera and the appropriate software.

In an embodiment, the electronic tag 1 includes a barometer. The control module 16 is configured to determine, using the barometer, whether the electronic tag 1 is airborne, in particular whether it is being transported on an aeroplane. The control module 16 may use one or more predefined pressure thresholds as indicative of the electronic tag 1 being airborne.

In an embodiment, the electronic tag 1 includes an accelerometer, for example a three-axis accelerometer. The control module 16 is configured to determine, using the accelerometer, whether the electronic tag 1 is currently being accelerated or not.

The control module 16 is configured to temporarily deactivate the wireless circuit 12 upon determining that the electronic tag 1 is currently airborne. The deactivated wireless circuit 12 does not transmit any wireless transmissions while it is deactivated. The control module 16 is configured to reactivate the wireless circuit 12 upon determining that the electronic tag 1 is no longer airborne.

Optionally, the control module 16 is configured to temporarily deactivate the wireless circuit 12 depending on the accelerometer reading.

In an embodiment, the electronic tag 1, in particular the control module 16, is configured to receive a status request message, for example from a wireless reader 3. The wireless reader 3 is described in more detail with reference to FIG. 2. The control module 16 is configured to transmit the status message to the wireless reader 3 upon reception of the status request message. The control module 16 may be configured to authenticate the status request message prior to transmission of the status message. The authentication may comprise verifying a digital signature or decrypting contents of the status request message.

The control module 16 may be configured to retransmit the status request message if a time-stamp in the status request message is no older than a pre-determined timeout period. The control module 16 may have an internal clock for this purpose. The status request message is, for example, retransmitted if it is no older than 5 seconds. Thereby, the status request messages from a wireless reader 3 are rebroadcast and electronic tags 1 not in direct communicative range with the electronic tag 1 receive the status request message. The time-out ensures that the wireless network is not flooded. Additionally, a stochastic wait period may be included prior to retransmission of the status request message.

Analogously, the control module 16 from a particular electronic tag 1 may be configured to retransmit a status message received from a further electronic tag 1, if a time-stamp included in the status message is no older than a pre-determined timeout period. Thereby, further electronic tags 1 not in direct communicative range with the wireless reader 3 may still communicate with the wireless reader 3. The stochastic wait period may also apply.

The electronic tag 1 may be configured to store, temporarily, an identifier of a wireless reader 3 included in the received status request message and/or an identifier of an electronic tag 1 included in the received status message and to not retransmit the status request message and/or the status message, respectively, if the identifier in the respective message matches a temporarily stored identifier. This further ensures that the wireless network does not flood, as each electronic tag 1 will only retransmit a particular message once. The electronic tag 1 may be configured to store the identifier for a period of 30 seconds, for example.

The electronic tag 1 may further be configured to enter a sleep mode after a sleep period has elapsed after receiving the status request message from the wireless reader 3.

FIG. 2 shows a block diagram illustrating schematically the product 2 attached or connected to the electronic tag 1. The electronic tag 1 is in data communication with an wireless reader 3. The wireless reader 3 is, for example, a fixedly installed or mobile wireless reader 3 configured to read values from the electronic tag 1 and/or write values to the electronic tag 1. The wireless reader 3 can comprise one or communication circuits, in particular wireless communication circuits configured for communication using a wireless local area network (WLAN), a mobile cellular network, Bluetooth (in particular, Bluetooth Low Energy), RFID (in particular, NFC) etc. In particular, the wireless reader 3 is configured to receive, from the electronic tag, in a status message, the one or more environmental measurement values and/or the one or more tamper status indicators. The status message comprises, for example, one or more most recent environmental measurement values and/or less recent (i.e. historical) environmental measurement value, the one or more environmental measurement values being retrieved from the memory. The status message further comprises, for example, one or more tamper status indicators, in particular a most recent tamper status indicator.

In an embodiment, the wireless reader 3 is configured to transmit, to one or more electronic tags 1 within communicative range, a status request message. The status request message may include a cryptographic key or a cryptographic signature, thereby enabling the electronic tag 1 to determine the authenticity of the wireless reader 3. The electronic tags are configured to transmit the status message to the wireless reader 3 upon receiving the status request message. The status request message may include a time-stamp.

In an embodiment, the status request message is transmitted, by the wireless reader 3, in a plurality of wake frames. The electronic tag 1 is configured to switch from a sleep mode to an active mode upon reception of the status request message. The electronic tag 1 responds to the status request message through transmission of the status message.

The status request message may be configured to receive only requested status indicators from the electronic tag 1. In particular, the electronic tag 1 may identify, in the status request message, one or more requested status indicators. The electronic tag 1 is configured to retrieve from memory the corresponding status indicators. Additionally or alternatively, the electronic tag 1 may be configured to perform one or more measurements to provide current values for the corresponding status indicators. The electronic tag 1 is configured to include, in the status message, the corresponding status indicators.

The electronic tag 1 may be configured to enter the sleep mode after a predetermined time-out period. In sleep mode, the electronic tag 1 consumes less electrical energy than in the awake mode.

Depending on the embodiment, the electronic tag 1, in particular the control module 16, is configured to include the address of the remote computer system in a message addressing part of the status message.

In an embodiment, the wireless reader 3 is configured to determine a received signal strength of the status message. The wireless reader 3 may be further configured to determine one or more angles of arrival (AoA) of the status message. The wireless reader 3 is configured to determine relative location information of the electronic tag 1 using the received signal strength and/or the angle(s) of arrival. The relative location may be, for example, a distance between the electronic tag 1 and the wireless reader 3. The relative location information may further comprise a direction to the electronic tag 1 relative to the wireless reader 3.

The wireless reader 3 may be configured to determine absolute location information of the electronic tag 1, using the relative location information and a geolocation of the wireless reader 3. The geolocation of the wireless reader may be a preconfigured geolocation, or it may be determined using, for example, a global navigation satellite system (e.g., GPS).

Depending on the embodiment, the wireless reader 3 is configured to authenticate the status message. For example, in an embodiment where the electronic tag 1 transmits a digitally signed status message, in particular signed using the stored cryptographic key, the wireless reader 3 is configured to authenticate the digitally signed status message using a second cryptographic key, the second cryptographic key being stored in the RFID reader 3 or retrieved from a further external device, for example a cloud-based server computer.

In an embodiment, the wireless reader 3 is configured to include or append, to the status message, location information of the electronic tag 1 (e.g. the relative location information and/or the absolute location information).

In an embodiment, the wireless reader 3 is configured to simultaneously read values from a plurality of electronic tags 1 within communicative range.

In an embodiment, the wireless reader 3 is configured to forward the status message received from the electronic tag 1 to the remote computer system, according to the address contained in a message addressing part of the status message, in particular using the one or more further communication circuits. For example, the remote computer system comprises a Blockchain platform (or a RPC server for forwarding the status message to the Blockchain platform) and/or a cloud-based computing platform.

In an embodiment, the wireless reader 3 is configured to receive status messages from a plurality of electronic tags 1 arranged in communicative distance with the wireless reader 3. The wireless reader 3 has a memory which is configured to record the status messages. The memory of the wireless reader 3 can further comprise an inventory list, the inventory list containing product information as described herein, in particular related to the plurality of products 2 attached to the electronic tags 1.

The wireless reader 3 is configured to determine whether the status message indicates that the environmental measurement values satisfy one or more pre-defined criteria and/or whether the tamper status indicators indicate that tampering has occurred.

The wireless reader 3 is configured to generate an event message if, for one or more status messages, the environmental measurement values do not satisfy the one or more pre-defined criteria and/or if the tamper status indicators indicate that tampering has occurred.

Depending on the embodiment, the event message can displayed on a display of the wireless reader 3. The event message can additionally, or alternatively, trigger an alarm (acoustic or visual). The event message can also be transmitted to a further device connected to the wireless reader 3 or the remote computer system.

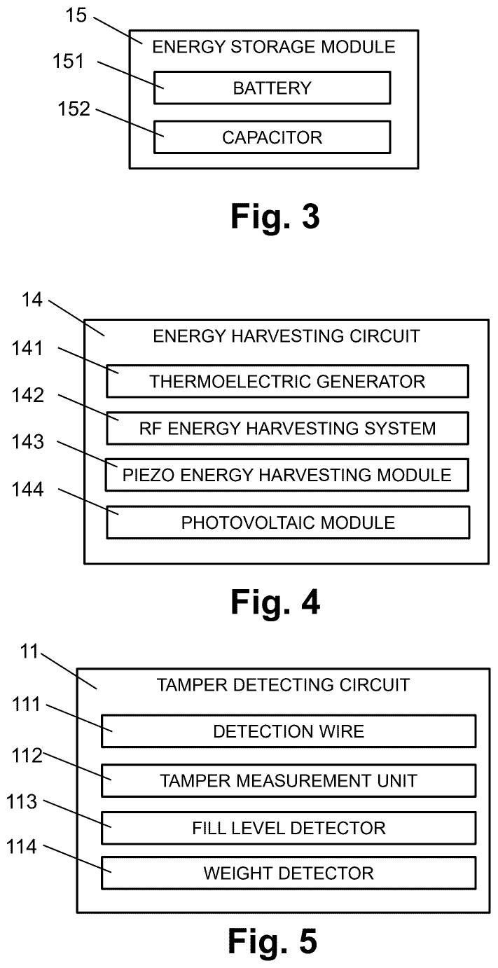

FIG. 3 shows a block diagram illustrating schematically an energy storage module 15. The energy storage module 15 comprises a battery 151 and/or a capacitor 152. The energy storage module 15 is connected to the control module 16 and the energy harvesting module 14. The energy storage module 15 is configured to receive energy from the energy harvesting module 14, store the received energy, and provide energy to the control module 16 for powering the control module 16 and other electronic components of the electronic tag 1. Depending on the power level of the energy storage module 15, all or only some of the electronic components of the electronic tag 1 are permitted to draw energy from the energy storage module 15.

The battery 151 is preferably a flexible battery, for example a flexible lithium-ion battery, such that the battery conforms to any bending, flexing, or twisting of the electronic tag 1. This is particularly beneficial in cases where the electronic tag 1 is implemented as flexible label adhesively fixed to the product. The capacity of the battery 151 is selected depending on the particular implementation, but is in the order of magnitude of 100 mAh. Depending on the implementation, the battery 151 is selected to have a capacity such that the electronic tag 1 has sufficient power for a pre-defined number of days, weeks, or months, for example 6 months.

The capacitor 152 is preferably a flexible capacitor or flexible pseudo-capacitor, more preferably a flexible super capacitor with a flexible electrode. This is particularly beneficial in cases where the electronic tag 1 is implemented as flexible label adhesively fixed to the product. Power is drawn from the capacitor 152 preferably when a high current is required by one or more of the electronic components of the electronic tag 1.

FIG. 4 shows a block diagram schematically illustrating an energy harvesting circuit 14. The energy harvesting circuit 14 is connected to the energy storage module 15 and is configured to provide electrical energy to the energy storage module 15. The energy harvesting circuit 14 comprises a thermoelectric generator 141, a radio-frequency (RF) energy harvesting system 142, a piezo electric energy harvesting module 143, and/or a photovoltaic module 144.

Depending on the embodiment of the invention, one or more of the aforementioned types of energy harvesting circuit 14 are implemented.

The thermoelectric generator 141 is configured to harvest electrical energy from a temperature gradient across the thermoelectric generator 141. The heat source responsible for the temperature gradient can be the product itself, if it generates heat, or can be an external heat source, for example the Sun. The thermoelectric generator 141 is preferably implemented as a thin-film thermoelectric generator 141 with a height preferably of less than 1 mm and configured to generate milliwatts of electrical power from just a few degrees Celcius of temperature difference. In such a manner, if it is foreseen that the electronic tag 1 will experience a temperature gradient, in particular between a front side of the electronic tag 1 and a back side of the electronic tag 1, the thermoelectric generator 141 provides for efficient energy harvesting.

The RF energy harvesting system 142 is configured to harvest electrical energy from radio-frequency transmissions, in particular in the bandwidths used by cellular networks (for example, the 3G, 4G, and/or 5G networks), wireless LAN transceivers, radio and TV transmitters, and/or microwave radios. Specifically, the bandwidth ranges from which electrical energy is harvested are between 600 MHz and 6 GHz (in particular 868 MHz and/or 915 MHz), as well as millimetre-wave 5G frequencies of approximately 24 GHz to 53 GHz. Of particular relevance for energy harvesting is the 2.4-2.5 GHz bandwidth (in particular 2450 MHz). In many environments, there is a large amount of electromagnetic activity in one or more of the aforementioned bandwidths. The RF energy harvesting system 142 comprises, for example, an antenna receiver, an impedance matching network, and a rectifying circuit. These components are designed according to the implementation of the RF energy harvesting system 142, in particular according to the bandwidths from which energy is to be harvested. In such a manner, if it is foreseen that the electronic tag 1 will be exposed to a large amount of RF energy, in particular in the 2.4-2.5 GHz bandwidth, then it is advantageous to implement the energy harvesting circuit 14 comprising the RF energy harvesting system 142.

The piezo electric energy harvesting module 143 is configured to convert kinetic energy in the form of vibrations or shocks into electrical energy. The piezo electric energy harvesting module 143 comprises a piezo electrical material, for example a single crystal, a ceramic, a polymer, and/or a composite material. Depending on the embodiment, the piezo electrical material is implemented in the form of a nanostructure, thin-film, or stacked layers. A deformation of the piezo electrical material is converted into electrical energy and transmitted to the energy storage module 15. In such a manner, if it is foreseen that the electronic tag 1 will be exposed to a large amount of movement, shocks, and/or vibration, then it is advantageous to implement the energy harvesting circuit 14 comprising the piezo electric energy harvesting module 143.

The photovoltaic module 144 is configured to convert light, in particular in the visible range, into electrical energy. The light comprises artificial light generated by lamps or other light emitting devices and/or natural sunlight. The photovoltaic module is preferably implemented as flexible thin-film module which is bendable, however the photovoltaic module can also be implemented as a rigid module. The photovoltaic module 144 is configured to provide electrical energy to the energy storage module 15. In such a manner, if it is foreseen that the electronic tag 1 will be exposed to light, then it is advantageous to implement the energy harvesting circuit 14 comprising the photovoltaic module 144.

FIG. 5 shows a block diagram illustrating schematically a tamper detecting circuit 11.

The tamper detecting circuit 11 may comprise a detection wire 111. The detection wire 111 comprises one or more conductive loops, implemented, for example, as a wire or conductive trace on a printed circuit board. The detection wire 111 is typically designed and arranged to cover an opening of the product (respectively the packing or container containing the product), such that any attempted tampering (e.g., opening or accessing the product) results in damage to the detection wire 111, resulting in changed electrical characteristics of the detection wire 111, in particular a resistance, conductance, or capacitance of the wire. For example, the attempted tampering results in the detection wire 111 being severed, leading to an open circuit. The tamper detecting circuit 11 may further comprise a tamper measurement unit 112 configured to perform a measurement of the electrical characteristics of the detection wire 111.

Depending on the implementation, the measurement is performed at regular time-intervals. In another example, the measurement is performed on-demand, for example upon the wireless reader 3 communicating with the electronic tag 1. In another example, the measurement is performed only when the tamper detecting circuit 11 has sufficient electrical energy available, in particular made available by the energy storage module 15 and/or the wireless reader 3.

The tamper detecting circuit 11 may be configured to provide to the control module 16 (e.g., transmit to the control module or make available to the control module) a tamper status indicator, which tamper status indicator depends on the electrical characteristics of the detection wire 111. In particular, the tamper status indicator is a binary value whose value depends on whether the electrical characteristics of the detection wire 111 are below or above one or more pre-defined threshold values. For example, the electrical characteristics of the detection wire 111 relate to a voltage drop across the detection wire 111, and the pre-defined threshold value is a particular pre-defined threshold voltage drop. If the tamper measurement unit 112 measures the voltage drop to be above the pre-defined resistance the current tamper status indicates that tampering has occurred, as a voltage drop above the pre-defined threshold resistance indicates damage and/or disruption of the detection wire 111. In another example, the electrical characteristics of the detection wire 111 relate to a capacitance of the detection wire 111.

The tamper detecting circuit 11 may be configured to detect a change in a quantity measure of a product 2 with which the electronic tag 1 is associated. The quantity measure is a measure of an amount of the product present. Depending on the embodiment, the product 2 may be a liquid, particular or granulate, or a collection of discrete units (such as pills). The electronic tag 1 may be attached directly to the product 2, or may be attached to a container within which the product 2 is stored. For example, the container may be a vial or bottle. The quantity measure may be indicative of a weight, a volume, or a number of items.

The change may be detected by the tamper detecting circuit 11 as a change relative to an initial amount determined by the tamper detecting circuit 11, for example an initial filling amount. The change may be detected by the tamper detecting circuit 11 as a change relative to one or more predetermined thresholds, in particular with a change detected when the quantity measure falls below a predetermined threshold.

The tamper detecting circuit 11 may be configured to register an initial amount responsive to a signal received during or after filling, packaging, or manufacture of the product 2.

The tamper detecting circuit 11 may be configured to generate the tamper status indicator upon a change in the quantity measure being detected. The tamper status indicator may be in the form of an analog and/or digital signal.

In an embodiment, the tamper detecting circuit 11 comprises a fill level detector 112, for example a capacitive sensor, configured to detect the change in the quantity measure as a change in the fill level of a liquid in the product 2, and to generate the tamper status indicator upon the fill level falling below a predetermined fill level threshold.

The fill level detector 112 may be configured to detect a discrete change or may be configured to detect continuous changes in the fill level. The fill level detector 112 may be configured to detect the fill level itself and/or a change in the fill level.

The fill level detector 112 may be configured such that the predetermined fill level threshold corresponds to a 80-95% fill level of the product 2, preferably 90% fill level of the product.

In an embodiment, the tamper detecting circuit 11 comprises a weight detector 114. The weight detector 114 is configured to determine a weight of the product or a change in the weight of the product. The weight detector 114 may be implemented, for example, as a pressure sensor arranged on a bottom side of the product. The weight detector 114 may include a piezoelectric pressure sensor and/or a capacitive pressure sensor.

The electronic tamper detecting circuit 11 may be configured to detect the change in the quantity measure as a change in the weight of the product and to generate the tamper status indicator upon the weight falling below a predetermined weight threshold. The predetermined weight threshold may correspond to 80-95% of an initial product weight.

The tamper detecting circuit 11 is configured to provide (e.g., transmit) the tamper status indicator to the control module 16.

The control module 16 is configured to store the tamper status indicator in the memory, preferably along with a current time-stamp. Depending on the implementation, only a single value of the tamper status indicator is recorded, in particular upon tampering being detected, or a plurality of tamper status indicators are recorded, e.g. in a data log.

The wireless reader 3, when connecting to the electronic tag 1, retrieves one or more tamper status indicators from the memory. Depending on the embodiment, the wireless reader 3 further retrieves a time-stamp associated with the one or more tamper status indicators, such that a time of tampering is traceable. Optionally, the data log can be retrieved from the memory.

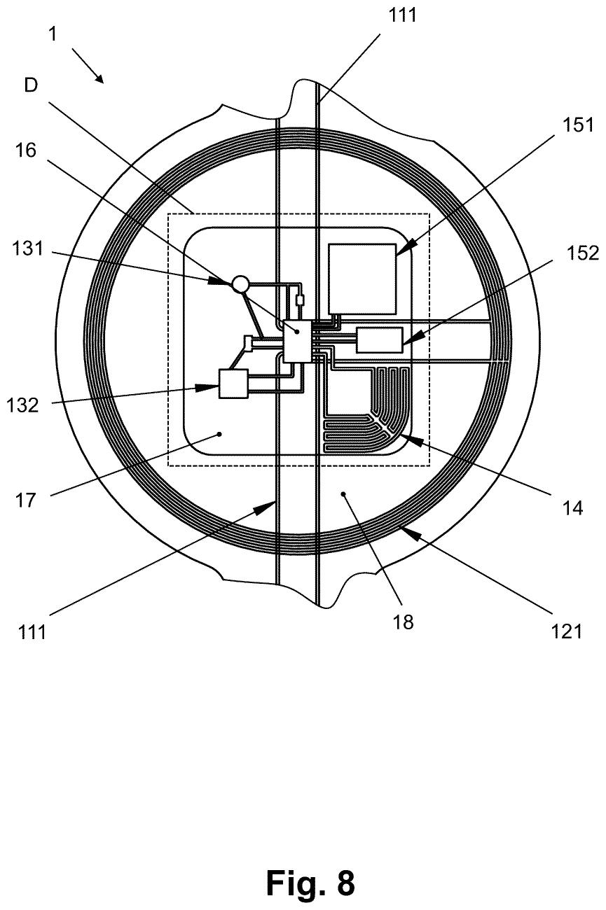

FIGS. 6a and 6b show top down views of an illustration of embodiments of the electronic tag 1, differing in the form of the antenna 121 of the wireless circuit 12. The electronic tag 1 is flat, with a central part in which most of the electronic components are arranged. The indicated section D of the central part is shown in detail in FIG. 8. The electronic tag 1 has two elongated parts which extend from the central part. The detection wire 111 extends along the elongated parts. The electronic tag 1 comprises a flexible body 18 onto which the various electronic components are arranged. The flexible body provides the structure of the electronic tag 1 and is substantially flat, with a back side and a front side. The back side preferably has an adhesive layer such that the electronic tag 1 can be bonded to the product.

The front side of the flexible body 18 features the electronic components. At least some of the electronic components can be attached to, or embedded into, the flexible body 18. In particular, the detection wire 111 and the wireless antenna 121 are attached to or embedded into the flexible body 18. At least some of the electronic components can be implemented on a flexible printed circuit board (FPCB) 17 which is itself attached to the flexible body 18.

The electronic tag 1, in particular the front side of the flexible body 18, is preferably covered by a flexible protective layer. In such a manner, the electronic tag 1 is sealed against the environment, in particular against water damage.

The embodiment shown in FIG. 6a features a substantially rectangular antenna implemented as a Bluetooth or RFID antenna 121. The embodiment shown in FIG. 6b features a substantially circular RFID antenna 121.

FIGS. 7a and 7b show perspective views of illustrations of the embodiments previously described with reference to FIGS. 6a and 6b, respectively. In these perspective views, the electronic tag 1 has been bent at folding areas 181 arranged between the central part and the elongated parts. That these folding areas 181 are arranged in those particular places of the electronic tag 1 is intended for illustrative purposes only, and other folding areas 181 are foreseen. In particular, it is foreseen that the elongated parts are continuously flexible and additionally, it is also foreseen that the central part housing a large part of the electronic components is also flexible. In such a manner, the electronic tag 1, or parts thereof, can be wrapped around bends on the product. In particular, the elongated parts can be arranged to cover an opening of the product (respectively the packaging or container containing the product).

FIG. 8 shows a detailed view of an embodiment of the electronic tag 1, in particular the section D of the central part of the electronic tag 1, as shown previously in FIGS. 6b and 7b. Specifically, an illustrative schematic of the electronic components of the electronic tag 1 is shown along with conductive traces connecting the various electronic components to each other.

The control module 16 is centrally located on the FPCB 17. In this embodiment of the invention, part of the wireless circuit 12, in particular a wireless transceiver, is implemented in the same integrated circuit as the control module 16. Similarly, the tamper measurement unit 112 of the tamper detecting circuit 11 is also implemented in the same integrated circuit as the control module 16.

The temperature sensor 131 and the humidity sensor 132 are arranged on the FPCB and connected to the control module 16 via conductive traces. The battery 151 is also directly connected to the control module 16 via conductive traces. The capacitor 152 is connected directly to the control module 16 via conductive traces.

The energy-harvesting module 14, in particular the RF energy harvesting system 143, comprises an antenna arranged on the FPCB and connected directly to the control module 16. The antenna of the RF energy harvesting system 143 features a wire loop in which a wire is tightly wound and arranged such that a substantial proportion of the area enclosed by the loop is filled with the wire. This compact arrangement results in a particularly efficient harvesting of RF energy. Depending on the frequency, the antenna can be a single-ended antenna or a loop, and the length and topology appropriately selected.

A single detection wire 111 is arranged extending in two different directions from the integrated circuit featuring the control module 16, in which the tamper measurement unit 112 is implemented. The detection wire 111 thereby extends towards both of the two elongated parts (not shown), respectively. In other embodiments, the detection wire 111 may also extend only to a single side (i.e. the electronic tag 1 has only a single elongated part).

The control module 16 is further connected to the antenna 121, which is implemented as a circular spiral on the flexible body 18 of the electronic tag 1.

FIGS. 9a to 9f show top down views of an illustration of various embodiments of the electronic tag 1 featuring different combinations of electronic components previously described with reference to FIGS. 6b, 7b, 8. Each of the shown embodiments has, among other components, an wireless circuit 12 comprising an antenna 121 (e.g., a Bluetooth or an RFID antenna), a control module 16, and a tamper detecting circuit 11 comprising a detection wire 111. As explained above with reference to FIG. 8, in these embodiments part of the wireless circuit 12 (in particular the transceiver) and the tamper detecting circuit 11 (in particular the tamper measurement unit 112) are implemented in the same integrated circuit as the control module 16.

FIG. 9a shows an embodiment having, in particular, a temperature sensor 131, a humidity sensor 132, and a battery 151. This embodiment is particularly useful for products 2 which should be stored at a specific temperature and/or humidity, for example wine or cigars, or products 2 which are best consumed at a particular temperature and/or humidity. A continuous measurement and recording of the environmental measurement values is particularly beneficial for such products 2.

FIG. 9b shows an embodiment having, in particular, a temperature sensor 131, a humidity sensor 132, a battery 151, and an RF energy harvesting system 14. This embodiment is particular useful for products 2 which require monitoring over a longer period of time, e.g. months or years, such that a single battery charge cannot power the electronic tag 1 long enough, and the RF energy harvesting system 14 provides supplemental power. An example of such a product 2 is prosciutto ham, or particular cheeses, which ripen over a long period of time and are required to be at a specific temperature and/or humidity.

FIG. 9c shows an embodiment having, in particular, a temperature sensor 131, a humidity sensor 132, a capacitor 152, and an RF energy harvesting system 14. This embodiment is particularly useful in conjunction with an active RFID circuit 12, wherein a high current is required intermittently for transmission of the status messages, the high current being supplied by the capacitor 152. The embodiment can be employed, for example, in warehouses or other situations where inventory management is necessary and it is not efficient or feasible to have the wireless reader 3 (in particular an RFID reader 3) in close proximity (e.g., close enough for passive RFID communication using, for example, NFC) with the electronic tag 1.

FIG. 9d shows an embodiment having, in particular, a temperature sensor 131, a humidity sensor 132, a battery 151, a capacitor 152, and an RF energy harvesting system 14.

FIG. 9e shows an embodiment having, in particular, a temperature sensor 131 and a battery 151. This embodiment is useful for increasing and/or ensuring the safety of the product 2, in particular by measuring and recording the temperature. For example, insulin is required to be kept below a particular temperature. For example, if insulin is heated to 30 degrees Celsius or higher for 4 hours, it is no longer as efficient and effective.

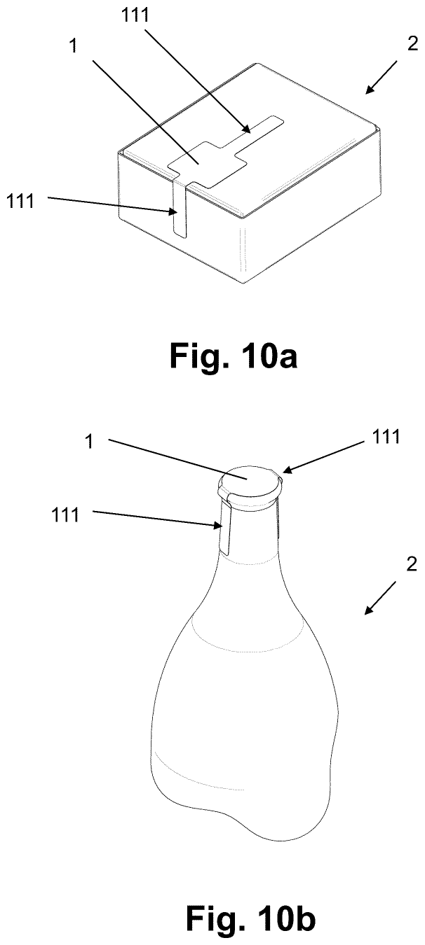

FIGS. 10a and 10b show an electronic tag 1 attached to a portable product 2. FIG. 10a shows the portable product 2 as a container or package. The electronic tag 1 is attached to the product 2 using an adhesive. The electronic tag 1 is attached such that one of the detection wires 111 extends across the edge of an openable section of the container, such that an attempted opening of the product 2 will result in the detection wires 111 being damaged or severed.

FIG. 10b shows an electronic tag 1 attached to a lid or cap of the product 2, embodied as a bottle. The detection wires 111 extend from the lid or cap to a body of the bottle, such that any attempted opening of the bottle will result in the detection wires 111 being damaged or severed.

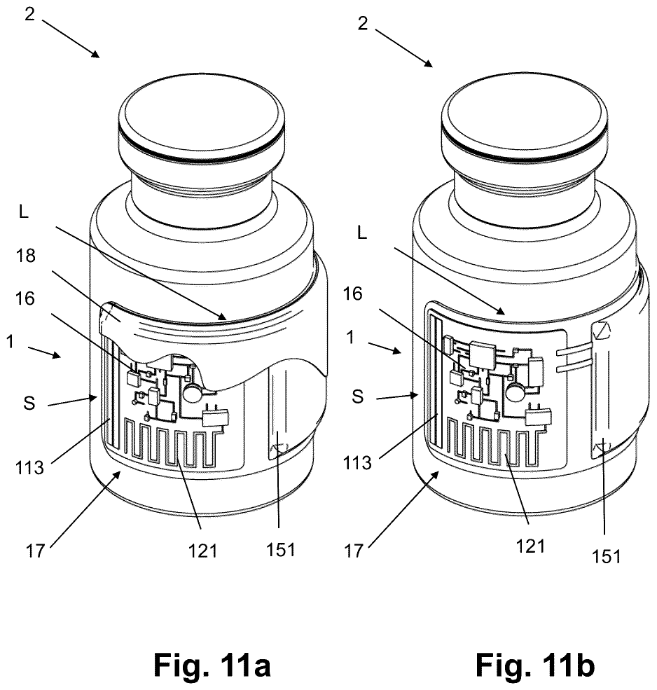

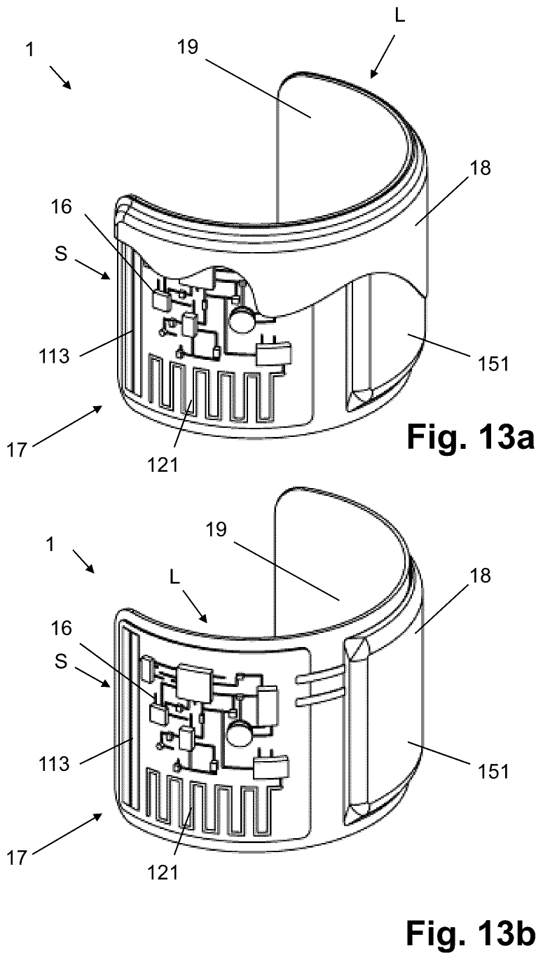

FIGS. 11a and 11b show a portable product 2 as a bottle (respectively, the product 2 may be contained in the bottle). The electronic tag 1 is implemented as a flexible tag adhesively attached to the outside of the bottle. To this end, the electronic tag 1 includes an adhesive backing layer 19 (shown in FIGS. 13a, 13b). On top of the adhesive backing layer, the electronic tag 1 includes a flexible circuit board 17 comprising the control module 16, the fill level detector 113, and the antenna 121. Further attached to the adhesive backing layer, and connected to the flexible circuit board 17, is a flexible battery 151. As seen in FIG. 11a, a flexible protective layer 18 covers the electronic tag 1.

The electronic tag 1 has a substantially rectangular overall shape with a first side L designed to wrap around the product 2 and a second side S which extends in the same direction as a cylinder axis of the cylindrically shaped product 2. The electronic tag 1 is designed such that components which are substantially inflexible are arranged in parallel with the second side S, while components which are flexible may extend in parallel with the first side L.

The fill level detector 113 is implemented, for example, as a capacitive sensor, which extends in parallel with the cylinder axis of the product 2 when applied to the portable product 2, such that a change in the fill level of the portable product 2 may be detected in a continuous manner. In another example, the capacitive sensor extends perpendicular to the cylinder axis of the portable product 2, in effect wrapping at least partially around the portable product 2, such that a change in the fill level of the portable product 2 may be detected in a discrete manner.

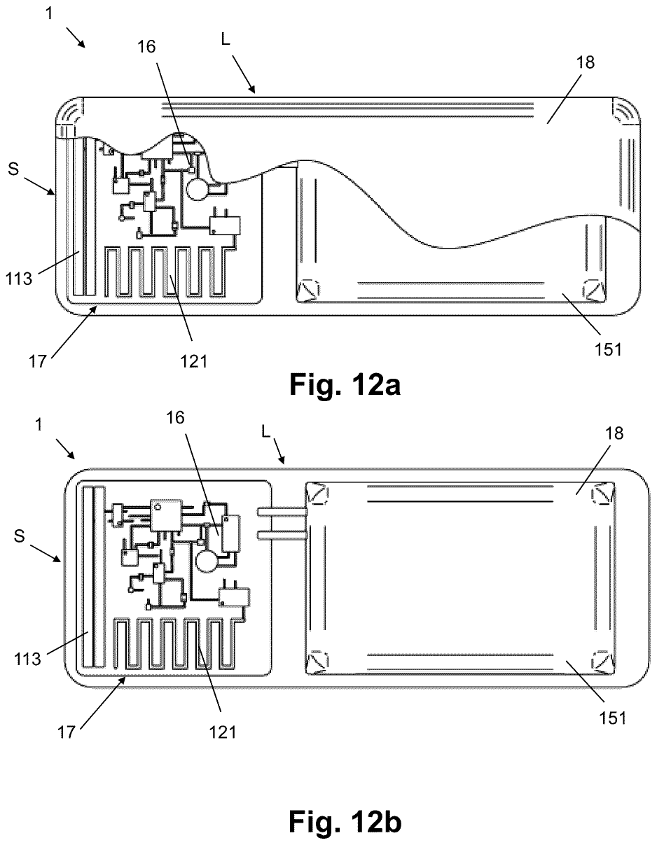

FIGS. 12a, 12b, and FIGS. 13a, 13b show the electronic tag 1 as described above in a flat and a curved state, respectively.

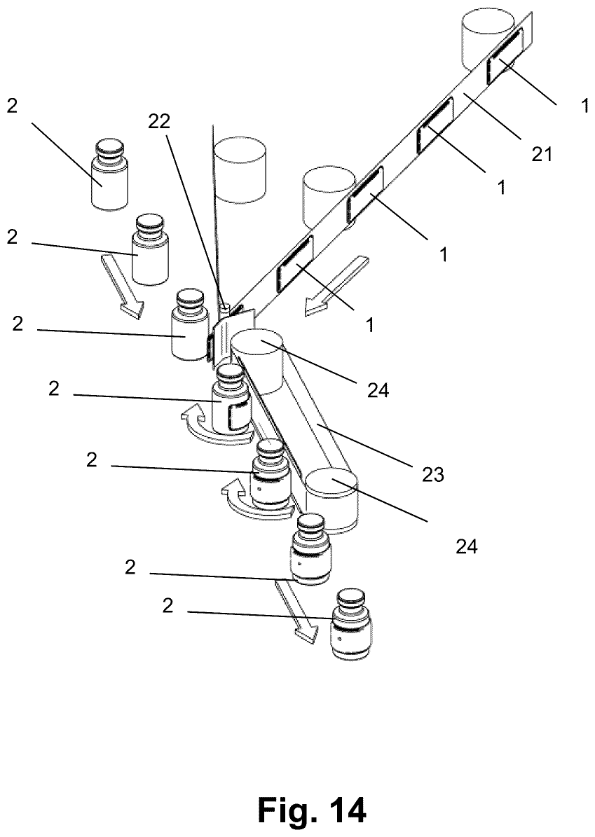

FIG. 14 shows a process of applying the electronic tag 1 to a product 2 during manufacture. The products 2, here a bottle or vial, are brought into contact with the electronic tags 1, which are then wrapped around the product 2. In particular, the electronic tags 1 are temporarily affixed to a carrier tape 21. The carrier tape is moved in the direction indicated by the arrow and is pulled around a roller 22 such that the electronic tag 1 peels off. Simultaneously, the product 2 is brought into contact with the adhesive side of the electronic tag 1. A belt 23 causes the electronic tag 1 to be applied to the product 2 by causing a rotation of the product 2 about its axis, as indicated by the curved arrows. The electronic tag 1 is then adhesively affixed to the product 2.

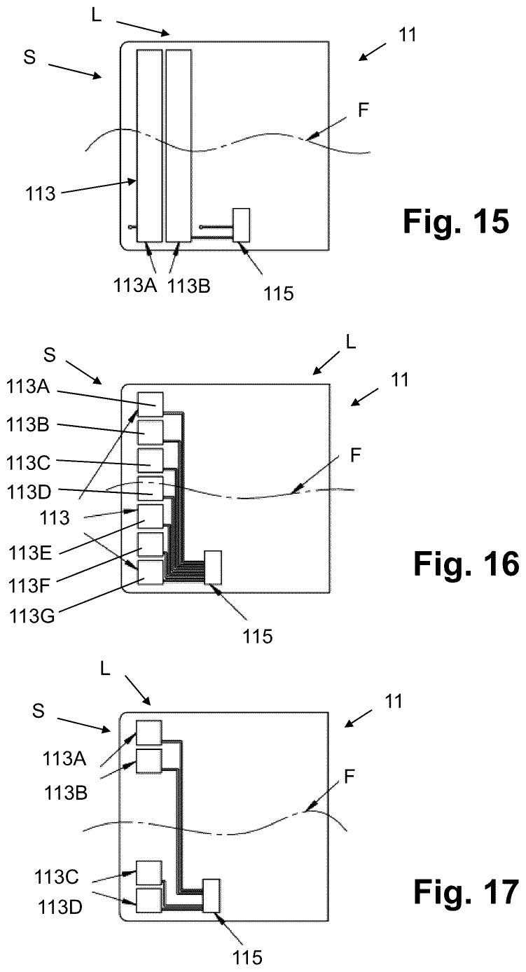

FIGS. 15 to 17 show embodiments of the electronic tamper detecting circuit 11 of the electronic tag 1, each including a capacitive sensor 113 configured to detect the change change in the fill level as a change in capacitance. The capacitive sensor 113 includes a plurality of electrical conductors 113A-113G are part of the electronic tamper detecting circuit 11. The conductors may be made of a suitable conducting material, for example a metal such as copper.

The electronic tamper detecting circuit 11 may further comprise a microcontroller 115 connected to the electrical conductors 113A-113G. The connection of the electronic tamper detecting circuit 11 to the control module 16 is not shown in the Figures.

The electronic tamper detecting circuit 11 is designed such that, when the electronic tag 1 is applied to a bottle (or other container or vessel, such as a vial) filled with a liquid, that the capacitance changes (either continually or in a more discrete fashion), based on a fill level F of the liquid. In such a manner, the electronic tamper detecting circuit 11 detects whether the bottle has been tampered with, that is to say, that liquid has been removed, wholly or partially, from the bottle.

The microcontroller 115 is configured to measure a capacitance across the capacitive sensor 113 and may be configured to generate the tamper status indicator and provide the tamper status indicator to the control module 16. Alternatively or additionally, the microcontroller 115 may provide the measured capacitance to the control module 16. The capacitance may be measured at pre-determined time-points and/or time intervals, or may be determined on demand.

The microcontroller 115 and/or the control module 16, respectively, may be configured to generate the tamper status indicator using the measured capacitance. In particular, the measured capacitance may be compared to one or more baseline capacitances, and the tamper status indicator generated according to whether a currently measured capacitance corresponds to the one or more baseline capacitances, exceeds the one or more baseline capacitances, and/or falls below the one or more baseline capacitances.

The baseline capacitances may be predefined capacitance values. The baseline capacitance values may alternatively or additionally be capacitances measured prior to filling of the liquid into the bottle, during filling of the bottle, and/or after filling of the bottle.

The fill level F may further be determined by interpolation and/or extrapolation of the measured capacitance with respect to the one or more baseline capacitance values. For example, if the measured capacitance corresponds to a particular baseline capacitance, this may be indicative of the fill level F having a first value. Other values for the fill level may be determined as a function of a deviation of the measured capacitance from the particular baseline capacitance.

In FIG. 15, the capacitive sensor 113 includes two planar conductors 113A, 113B arranged substantially coplanar next to each other, separated by a predefined separation distance. The conductors 113A, 113B may have a rectangular shape with a height measured along a long axis extending in parallel to the second side S and a width measured along a short axis extending in parallel to the long side L. The fill level F is indicated by the dashed line. The long axis of the conductors 113A, 113B is orthogonal to the fill level F. A changing fill level F of the liquid results in a changing value of the capacitance between the two conductors 113A, 113B due to a change in the electrical permittivity on the inside of the bottle caused by the presence or absence of liquid. Therefore, by measuring the capacitance between the two conductors 113A, 113B, and by comparing the measured capacitance to the one or more baseline capacitances, the electronic tamper detecting circuit 11 (or the control module 16) is configured to detect a change in capacitance, thereby indicating a change in the fill level F. Thereby, tampering may be detected.

A reduction in the capacitance is typically indicative of a reduction in the fill level F, however this depends on the nature of the liquid, in particular its electrical permittivity relative to that of air.

For example, the electronic tamper detecting circuit 11 may be configured to transmit a tamper status indicator if the measured capacitance, as compared to the baseline capacitance, is indicative of the fill level F falling below a predefined level. The predefined fill level F may be expressed as a proportion of the total volume of liquid in the portable product 2, as a height of the fill level F either with respect to a total height of the portable product 2 or with respect to a height (i.e. the extension along the long axis) of the conductors 113A, 113B. In one example, if the electronic tamper detecting circuit 11 measures a drop in the capacitance below a baseline capacitance (e.g. a baseline capacitance corresponding to a value of the capacitance when the fill level F meets or exceeds the height of the conductors 113A, 113B, the electronic tamper detecting circuit 11 may generate the tamper status indicator.

In FIG. 16, the capacitance sensor 131 includes a vertically arranged array of coplanar conductors 113A-113G. The conductors are arranged in a line parallel to the short side S of the electronic tag 1, such that a changing fill level F results in the fill level F moving past the conductors 113A-113G such that they may be considered to be over, at, or under the fill level F. The electronic tamper detecting circuit 11 is configured to measure the capacitance between pairs of the conductors 113A-113G, in particular between adjacent pairs of conductors, (e.g., between the first and second conductors 131A, 131B, the second and third conductors 131B, 131C, etc.), and to compared the measured capacitance with one or more baseline capacitances, to determine the fill level F. The fill level F may be determined in a discrete manner or in a continuous manner.

In an example, a baseline capacitance corresponds to a measured capacitance in a situation where the fill level F exceeds a height of both conductors 113A-113G of a pair of conductors 113A-113G. Thereby, a drop in the measured capacitance below this baseline capacitance is indicative of the fill level F not exceeding the height of both conductors 113A-113G. Thereby, by measuring the capacitance across pairs of mutually adjacent conductors 113A-113G, and comparing each measured capacitance with the baseline capacitance, it may be determined, at least approximately, where the fill level F lies.

The conductors 113A-113G preferably have the same geometric shape, for example a square shape. They may be arranged in a vertical line with respect to an installed orientation of the electronic tag 1. The conductors 113A-113G are separated by a defined separation distance.

For example, if the capacitance between a pair of adjacent conductors 113A-113G drops, then that is indicative of the fill level F no longer exceeding the height of the top conductor of the conductor pair 113A-113G. Gradual changes in capacitance between pairs of conductors 113A-113G may also be measured and used when generating the tamper status indicator.

In FIG. 17, the capacitance sensor 131 comprises a top pair of conductors 131A, 131B, and a bottom pair of conductors 131C, 131D. The top pair of conductors 131A, 131B enables a determination of whether the fill level F has dropped below an upper threshold level, the top threshold level being in the region of the top pair of conductors 131A, 131B. The bottom pair of conductors 131B, 131C enables a determination of whether the fill level F has dropped below a lower threshold level, the lower threshold level being in the region of the bottom pair of conductors 131B, 131C. The conductors 131A-131D in each pair of conductors 131A-131D may be separated by a defined separation distance, and the pairs of conductors 131A, 131B and 131C, 131D may be separated by a further separation distance.

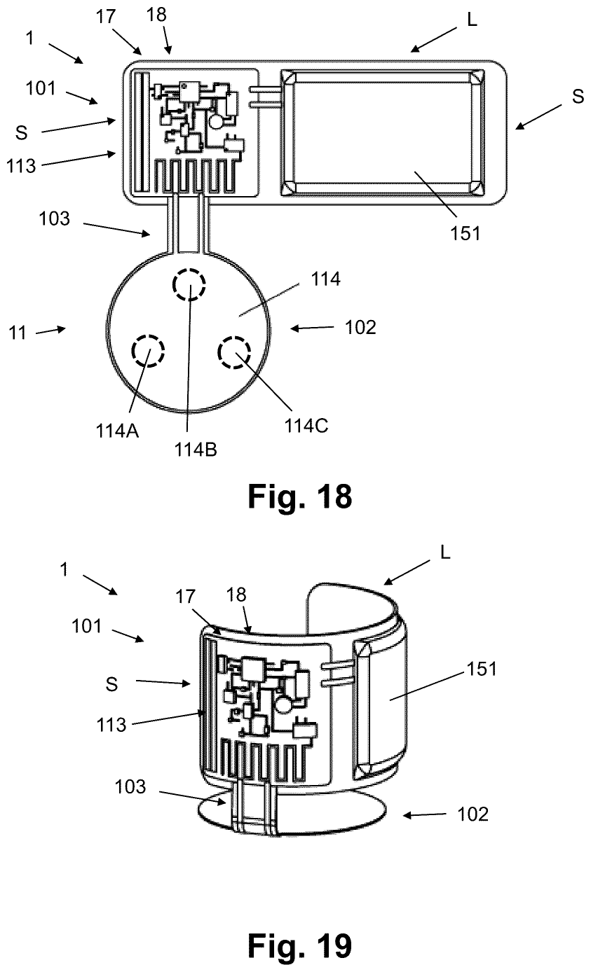

FIG. 18 shows an electronic tag 1 in which the electronic tamper detecting circuit 11 includes a weight detector 114. The weight detector 114 is arranged in an extension 102, which is separated from the main body 101 of the electronic tag 103 by a flexible connector 102. The flexible connector 102 includes an electrical connection between the weight detector 114 and the control module 16.

The extension 102 is designed such that when the electronic tag 1 is applied to a portable product 2 (or a container containing the portable product 2) the extension 102 covers a bottom of the portable product 2 at least partially. In particular, the extension 102 is designed such that the weight detector 114 is arranged between a bottom surface of the portable product 2 and a support surface on which the portable product 2 is placed, such that the entire weight of the portable product 2 goes through the weight detector 114 and the weight of the portable product 2 may be determined.

The extension 102 has, for example, a shape corresponding to a shape of the bottom of the portable product 2. For example, the extension 102 has a circular shape for round portable products 2. The extension 102 may be a filled circle or a circle with a central cutout (e.g., a central circular cutout), for example in cases where the portable product 2 is a bottle with an indented bottom surface (i.e. some types of wine bottles).

The flexible connector 103 is flexible (can be bent) such that when the electronic tag 1 is applied to the portable product 2 with the main body 101 of the electronic tag 1 applied to a side of the portable product 2, the extension 102 can be applied to the bottom of the portable product 2. The flexible connector 103 preferably includes two conductors for connecting the weight detector 114 to the control module 16.

The main body 101, extension 102 and flexible connector 103 preferably share a single adhesive backing 19.

The weight detector 114 may comprise one or more weight sensors arranged in the extension 102. In one example, the entire extension 102, or at least a majority of the extension 102 by area, is a weight sensor. In another example, only parts of the extension 102 include weight sensors, e.g. the extension 102 includes three weight sensors 114A, 114B, 114C arranged equidistant from a center of the extension 102 and evenly distributed (triangular arrangement).

The weight detector 114 and/or the weight sensors may include one or more piezo-electric pressure sensors. The weight detector 114 and/or the weight sensors may include one or more capacitive pressure sensors.

The electronic tamper detecting circuit 11 is configured to measure the weight of the portable product 2, using the weight detector 114, at one or more time-points. The weight may be measured at defined time-intervals, or measured on demand through reception of an appropriate signal from a device interrogating the electronic tag 1.

The measured weight of the portable product 2 is then compared to either a baseline weight. The baseline weight may be predefined or may be based on an initial measurement of the portable product 2. For example, in a case where the portable product 2 is a container, such as a bottle including contents, prior to filling or after filling of the bottle. The electronic tamper detecting circuit 11 is configured to generate the tamper status indicator if the measured weight deviates from the baseline weight by a defined margin, which margin may be defined as an absolute and/or relative margin with respect to the baseline weight.

For example, if the baseline weight was established after filling to be 30 g, then the electronic tamper detecting circuit 11 may be configured to generate the tamper status indicator if the weight is measured to be below 26 g, therefore using a margin of 4 g. The precise values may depend on the use-case and implementation, the empty weight of the bottle, the filled weight of the bottle, the type of product contained in the bottle, etc.

The electronic tamper detecting circuit 11 may further include a capacitive sensor 113. In an example, the electronic tamper detecting circuit 11 is configured to generate the tamper status indicator upon both the fill level detector 131 and the weight detector 114 measuring a change with respect to a baseline capacitance and a baseline weight, respectively. Alternatively, the electronic tamper detecting circuit 11 is configured to generate the tamper status indicator upon either the fill level detector 131 or the weight detector 114 measuring a change with respect to a baseline capacitance and a baseline weight, respectively.

The electronic tag 1 may further comprise a detection wire 111 and a tamper measurement unit 112. The detection wire 111 extends from the main body 101 such that, when the electronic tag 1 is applied to the portable product 2, the detection wire 111 covers, at least partially, an opening of the portable product 2. In an example where the portable product 2 is a bottle, the detection wire 111 may extend over the opening of the bottle, in particular over a top of the bottle, such that if the top is opened, the detection wire 111 is damaged and tampering may be detected.

FIG. 19 shows the electronic tag 1 of FIG. 18 in an applied state (with the bottle not shown). The extension 102 is arranged in a horizontal plane orthogonal to the main body 101. The flexible connector 103 is bent, thereby connecting the extension 102 to the main body 101 physically and electrically.

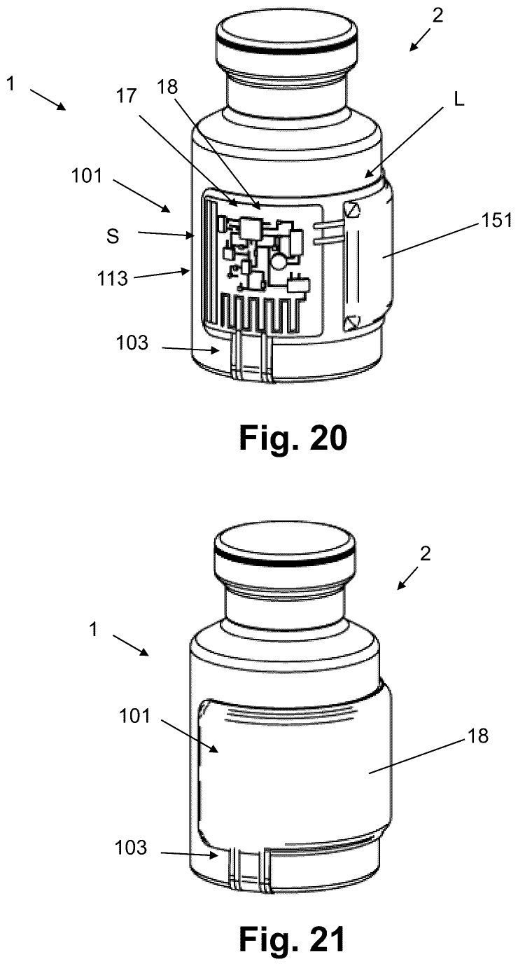

FIGS. 20 and 21 show the electronic tag 1 of FIG. 19 including the portable product 2 (in this instance, a bottle).

It should be noted that, in the description, the sequence of the steps has been presented in a specific order, one skilled in the art will understand, however, that the order of at least some of the steps could be altered, without deviating from the scope of the disclosure.

1. A method of controlling access to a space using an access control device and a user's mobile communication device, the method comprising:
operating, by the access control device, a Bluetooth communication circuit of the access control device in a peripheral role;
transmitting, by the access control device, an advertising packet, the advertising packet comprising a designator associated with the space;
operating, by the mobile communication device, a Bluetooth communication circuit of the mobile communication device in a central role;
receiving, by the mobile communication device, the advertising packet;
determining, by the mobile communication device, whether the access control device is relevant for the user, wherein determining whether the access control device is relevant for the user comprises using the designator, received in the advertising packet, and access right data stored in the mobile communication device;
upon determining that the access control device is relevant for the user, establishing, by the mobile communication device, a connection between the Bluetooth communication circuit of the mobile communication device and the Bluetooth communication circuit of the access control device; and
executing, by the mobile communication device and the access control device, an access control protocol via the connection, wherein executing the access control protocol
transmitting, by the mobile communication device, access control data to the access control device, and
checking, by the access control device, permission of the user to access the space by verifying the access control data from the mobile communication device.

2. The method of claim 1, further comprising:
receiving, by the mobile communication device, advertising packets from a plurality of access control devices; and
upon determining that more than one access control device is relevant for the user, determining, by the mobile communication device, a selected access control device, and establishing the connection with the Bluetooth communication circuit of the selected access control device.

3. The method of claim 2, wherein the determining the selected access control device comprises using received signal strength indicators determined for the relevant access control devices.

4. The method of claim 2, wherein the determining the selected access control device comprises using position or distance information, determined for the relevant access control devices using an ultra-wide-band transceiver.

5. The method of claim 2, wherein the determining the selected access control device comprises displaying, on a display, a list of the relevant access control devices and receiving a user selection of the selected access control device.

6. The method of claim 1, further comprising:
generating, by the access control device, at least one of: a randomized designator, by applying randomization to the designator associated with the space, or an encrypted designator, by encrypting the designator associated with the space, and
transmitting the randomized or encrypted designator to a remote server.

7. The method of claim 6, wherein transmitting the randomized or encrypted designator comprises transmitting via the mobile communication device to the remote server.

8. The method of claim 1, further comprising:
operating, by the access control device, the Bluetooth communication circuit of the access control device in a broadcaster role to function intermittently as a beacon by transmitting advertising packets without allowing connections; and
displaying, by the mobile communication device, on a display a spatial arrangement of a plurality of access control devices functioning as beacons.

9. A mobile communication device comprising:
a Bluetooth communication circuit; and
a processor connected to the Bluetooth communication circuit, the processor being configured to:
operate the Bluetooth communication circuit in a central role,
receive an advertising packet from an access control device controlling access to a space,
extract, from the advertising packet, a designator associated with the space,
determine whether the access control device is relevant for a user of the mobile communication device by using the designator and access right data stored in the mobile communication device,
upon determining that the access control device is relevant for the user, direct the Bluetooth communication circuit to establish a connection with the access control device, and
execute an access control protocol via the connection, wherein execute the access control protocol includes direct the Bluetooth communication circuit to transmit access control data to the access control device, enabling the access control device to check permission of the user to access the space.

10. The mobile communication device of claim 9, wherein the processor is further configured to:
receive advertising packets from a plurality of access control devices,
upon determining that more than one access control device is relevant for the user, determine a selected access control device, and
establish the connection with the selected access control device.

11. The mobile communication device of claim 10, wherein the processor is further configured to determine the selected access control device, using received signal strength indicators determined for the relevant access control devices.

12. The mobile communication device of claim 10, wherein the mobile communication device comprises an ultra-wide-band transceiver, and the processor is further configured to determine for the relevant access control devices position or distance information, using the ultra-wide-band transceiver, and to determine the selected access control device using the position or distance information.

13. The mobile communication device of claim 10, wherein the processor is further configured to determine the selected access control device by displaying on a display a list of the relevant access control devices, and receiving a user selection of the selected access control device.

14. The mobile communication device of claim 9, wherein the processor is further configured to receive from the access control device a randomized or encrypted designator associated with the space and to transmit the randomized or encrypted designator securely via a mobile radio network to a remote server.

15. A computer program product comprising a non-transitory computer readable medium having stored thereon computer program code configured to direct a processor of a mobile communication device to perform:
operating a Bluetooth communication circuit of the mobile communication device in a central role;
receiving an advertising packet from an access control device controlling access to a space;
extracting from the advertising packet a designator associated with the space;
determining whether the access control device is relevant for a user of the mobile communication device by using the designator and access right data stored in the mobile communication device;
upon determining that the access control device is relevant for the user, directing the Bluetooth communication circuit to establish a connection with the access control device; and
executing an access control protocol via the connection, wherein executing the access control protocol includes the processor directing the Bluetooth communication circuit to transmit access control data to the access control device, enabling the access control device to check permission of the user to access the space.

16. The computer program product of claim 15, wherein the computer program code is further configured to:
direct the processor to receive advertising packets from a plurality of access control devices;
upon determining that more than one access control device is relevant for the user, determine a selected access control device; and
establish the connection with the selected access control device.

17. The computer program product of claim 16, wherein the computer program code is further configured to direct the processor to determine the selected access control device using received signal strength indicators determined for the relevant access control devices.

18. The computer program product of claim 16, wherein the computer program code is further configured to:
direct the processor to determine for the relevant access control devices position or distance information, using an ultra-wide-band transceiver of the mobile communication device; and
determine the selected access control device using the position or distance information.

19. The computer program product of claim 16, wherein the computer program code is further configured to:
direct the processor to determine the selected access control device by displaying, on a display, a list of the relevant access control devices, and receiving a user selection of the selected access control device.

20. The computer program product of claim 15, wherein the computer program code is further configured to:
direct the processor to receive from the access control device a randomized or encrypted designator associated with the space; and
transmit the randomized or encrypted designator securely via a mobile radio network to a remote server.

21. An access control device for controlling access to a space comprising:
a Bluetooth communication circuit; and
a processor connected to the Bluetooth communication circuit, the processor being configured to perform:
operating the Bluetooth communication circuit in a peripheral role,
transmitting an advertising packet, the advertising packet comprising a designator associated with the space, the designator enabling a mobile communication device receiving the advertising packet to determine whether the access control device is relevant for a user of the mobile communication device,
receiving, from the mobile communication device having determined that the access control device is relevant for the user, a connection request,
directing the Bluetooth communication circuit to establish a connection with the mobile communication device, and
executing, via the connection, an access control protocol with the mobile communication device, wherein executing the access control protocol includes receiving from the mobile communication device access control data and checking permission of the user to access the space by verifying the access control data.

22. The access control device of claim 21, wherein the processor is further configured to:
generate at least one of: a randomized designator, by applying randomization to the designator associated with the space, or an encrypted designator, by encrypting the designator associated with the space, and
transmit the randomized or encrypted designator to a remote server.

23. The access control device of claim 21, wherein the processor is further configured to direct the Bluetooth communication circuit to operate intermittently in a broadcaster role to make the access control device function as a beacon, by transmitting advertising packets without allowing connections.
